(19) United States
(12) Patent Application Publication
(10) Pub. No.: US 2025/0363720 A1
(43) Pub. Date: Nov. 27, 2025

(54) Building and Outdoor Environment Advanced Particle Ray Tracing and Duplication in Real and Virtual Environments Non-Provisional Patent Application

(71) Applicant: Forward Entertainment & Technology LLC, Washington, DC (US)

(72) Inventors: James Lowell Ramsey Clarke, Washington, DC (US); Chiedo Raymond Ohanyerenwa, Washington, DC (US); William Huston, Fremont, CA (US); Rodney Palmer, Port Tobacco, MD (US); David Kyle Miller, Fort Washington, MD (US); John Ramsey Clarke, Lawrence Township, NJ (US)

(73) Assignee: Forward Entertainment & Technology LLC, Washington, DC (US)

(21) Appl. No.: 19/218,616

(22) Filed: May 27, 2025

Related U.S. Application Data
(60) Provisional application No. 63/652,166, filed on May 27, 2024.

(51) Int. Cl. G06T 15/06

(52) U.S. Cl. CPC G06T 15/06

(57) ABSTRACT

The present disclosure encompasses apparatuses, methods and systems for monitoring, predicting, replicating and simulating particle ray tracing and interfacing said tracing with alert, response, measurement and entertainment systems or devices in an ergonomic fashion. Among the objectives of this disclosure is to provide related variations to designs that protect, guide, inform, or entertain users or systems. In order to accomplish this feat, the disclosure requires one or more particle ray observation sensors (PROS), which observe particles and their movement and send a signal to one or more particle ray response relays (PRRR), which perform an action in response to a said signal. Developments from this disclosure can be used to build safety devices that assist users, protect users from danger, duplicate live music in other real or virtual environments, and help commercial assessors value buildings, renovations or optimal use of space with the aid of Artificial Intelligence, lights and lasers.

### CROSS-REFERENCE TO RELATED APPLICATION

The present application claims priority to U.S. Provisional Patent Application No. 63/652,166, filed May 27, 2024. The entire disclosure of U.S. Provisional Patent Application No. 63/652,166 is incorporated herein by reference.

### TECHNICAL FIELD

The present invention relates to computer vision and Internet of Things (IoT) technologies, specifically a system and method for building ergonomics and information transmission. In some such embodiments this may involve a system that takes observations of particles and duplicates them in a virtual embodiment to generate predictions for warning systems, alarms or other guidance. In other such embodiments this may involve devices that autonomously transform pathways for particles that may be generated in the form of lights or lasers of different wavelengths and speeds to interact and form reflective surfaces which may be angled to trap other lights or lasers in some such embodiments carrying information which may continue to form pathways guided to transmit messages in unique patterns via particle physics and alter pathways based on observed particles in combination with predictive technologies in some such embodiments. In some such embodiments these abilities can be enhanced with the aid of artificial intelligence.

The general field of the disclosure incorporated by reference more broadly relates to the design of an apparatus, method, and system for particle ray tracing. More specifically, this apparatus, method, and system involves an apparatus, method or system of mapping, estimating, predicting or simulating particles and their movement, including but not limited to physical particles, light particles, and sound particles. In some embodiments, these particles may be mapped against estimates or data of one or more user locations and/or environments, for purposes including but not limited to collision warning systems, turn by turn navigation, duplication of sound in real or simulated environments, a recreation of images in a virtual environment based off of detected light, or a combination of some such embodiments. In other embodiments, an Artificial Intelligence may interface with a database housing data regarding said real or simulated environments and use that data in order to effectively predict particle motion, user behavior or guide one or more users' movement in relation to said particle motion.

The apparatus, methods, and systems of the disclosure may be focused on safety related guidance in some such embodiments, audio and visual simulation or replication of detected particle motion and guidance, in other such embodiments, or hospitality-based service alerts, in some other such embodiments. This also encompasses autonomous and semi-autonomous variations of this device, in some cases with acoustic sensors, tactile sensors or some other interoperating sensors in conjunction with speakers or visual displays, including but not limited to LCD screens and headsets.

### BACKGROUND

The present disclosure has many practical applications. Among these are predictive, observation enhancement and information or particle transference. Predictive technologies better enabled through this may include preventive maintenance enhancement (including but not limited to in medical applications such as dentistry or internal cleansing, industrial applications such as in power or water plants, or commercial applications such as external cleansing or observation enhancement), collision avoidance both indoor and out and Particle transference (including but not limited of lights, lasers, sound or more stationary particles). In some such embodiments a plurality of particles may interact to generate fields which may reflect, propel, trap, or otherwise interact with one another to guide information such as a digital fiber optic cable. In some such embodiments the energy to generate such streams may be generated by exotic energy sources including but not limited to solar energy, metamaterial interactions, cold fusion (www.lenr-canr.org/acrobat/GotzmerClipdrhdoel.pdf, Carl Gotzmer, Louis F. DeChiaro et al. “Li—Pd—Rh_D₂O electrochemistry experiments at elevated voltage”, visited May 26, 2024) or low-energy nuclear reactions (spectrum.ieee.org/cold-fusion-or-low-energy-nuclear-reactions-us-navy-researchers-reopen-case, Michael Koziol, IEEE “Whether Cold Fusion or Low-Energy Nuclear Reactions, U.S. Navy Researchers Reopen Case”, visited May 26, 2024). Dental uses for this disclosure include utilizing observation pathways for observation and providing information in autonomous systems that aid practitioners that allowing them to better perform their task. This may include utilizing one or more particle turrets to generate, move or otherwise manipulate a series of mirrors in some space, while some portion of other intentionally released particles are guided by the emissions from the turrets, the mirrors, or some combination therein.

Ray tracing is a method in physics “for calculating the path of waves or particles through a system with regions of varying propagation velocity absorption characteristics, and reflective surfaces.” (en.m.wikipedia.org/wiki/Ray_Tracing_(physics), Wikipedia, Ray tracing (physics), visited May 26, 2024). However, particles are not just limited to lose connected atoms in the atmosphere, they are the makeup of elements, including but not limited to atoms and their components, described as the building blocks of the universe. All matter is composed of particles. Energy including light, sound, and charge are composed of particles. Even gravity and theoretical energy such as dark energy are theorized to be composed of particles. With reference to this disclosure, the particles discussed are limited to those that have been detected or that may be simulated and generated in four dimensions, in a physical space and time.

For the purpose of this disclosure, the goal is to advance the art by optimizing the detection, prediction, and simulation of particles for ergonomic use in real and virtual embodiments. Existing intellectual property in this arena is scattered and varied, and at a level of advancing the technology for greater production of data with regard to the real and virtual world, but without advanced synthesis to the human body for ergonomic use. The embodiments disclosed herein further advance the useful arts by ensuring the tech is responsive and aligned with human senses in an ergonomic way to ensure more realistic duplication of real world data is incorporated into virtual environments in some embodiments, more accurate detection of safety and direction based on particle movement in real embodiments is relayed ergonomically to the user or devices protecting or guiding the user in other embodiments, and that data or alerts related to hospitality such that service may be rendered or optimized for users or creators in some other such embodiments or a combination therein.

### SUMMARY OF THE INVENTION

The present disclosure encompasses apparatuses, methods, and systems for monitoring, predicting, replicating, and simulating particle ray tracing and interfacing said tracing with alert, response, measurement, and entertainment systems or devices in an ergonomic fashion. Among the objectives of this disclosure is to provide related variations to designs that protect users, guide users, inform users, or entertain users. In order to accomplish this feat, the disclosure requires one or more particle ray observation sensors (PROS), which observe particles and their movement and send a signal to one or more particle ray response relays (PRRR), which perform an action in response to a said signal.

Examples of variations of the present disclosure that are designed to protect users include but are not limited to one or more PROS and/or one or more PRRRs in a headset that may be used to provide a user with alerts, guidance, or protection, one or more PROS and/or one or more PRRRs in a surgical instrument, and one or more PROS and/or more PRRRs in a constructed or under construction facility. One such example for alerts for a headset may be a headset that can be used in conjunction with the operation of a vehicle including but not limited to bicycles, mopeds, and motorized scooters, in which the PROS observes the motion of other particles, associates them with hazards, and sends a signal to PRRRs to guide the user on their path in relation to said particles. One such example for guidance for a headset may be a headset in embodiments that may have PRRRs that respond by alerting the user to a hazard via an audio signal, visual signal, or combination therein and guide the user to avoid a danger on their path. One such example for protection with a headset may involve embodiments that may have PRRRs separate from the headset, including but not limited to air expansion devices on pads, including but not limited to within a helmet, arm bands, leg bands, or a safety suit, that inflate in response to an imminent collision.

Another such example for protection with a headset may involve embodiments that have PRRRs in the headset where sound dampening may be triggered in response to a loud noise being detected by the PROS so as to shield the user's ears, light dampening being triggered in response to a high lumens either detected or predicted by the PROS so as to shield the user's eyes, or the release of oxygen embedded in the headset, to protect the users life or olfactory senses, depending on the situation if a particularly noxious gas is detected by the PROS. One such example for protection in a surgical instrument may be an instrument for oral surgery with PROS embedded that detects that a user with temporomandibular joint disfunction's (TMJ's) mouth is opened too wide for too long, based on observed particle data in conjunction with prior scans, and sends a signal to PRRRs, such as Bluetooth earphones worn by the oral surgeon, to pause so that the patient can relax their jaw. One such example of alerts, guidance and protection for a constructed or under construction facility may be PROS set up around a hotel, that sense vibrations from an earthquake, and send a signal to one or more PRRRs embedded in vibration dampening devices, to begin countermeasure movements in response to the magnitude of the earthquake detected, in some such embodiments, PROS detect the presence of users throughout the facility, and the PRRRs send a signal to guide responders to said areas, react to guide debris to less occupied areas, or send an alert to users when it is safe to move between tremors, so that they may safely exit the building. Other examples of embodiments meant to protect users may involve clothing or hardware with PRRRs that move in response to PROS on the user detecting fainting, falling, or other undesirable movement, and guide the user to stand upright or brace for impact in a way that will best shield them. In some such embodiments, artificial intelligence may be used to record data regarding one or more users and provide guidance in the future to the users or the systems based on previously observed data and newly observed data, making calculations and adjusting over time, including by providing training and recommendations to users or systems in some such embodiments.

Examples of the present disclosure designed to entertain users may include but are not limited to audio/visual PROS that may observe or record a performance, PRRRs that may replicate said performance in another environment based on a combination of calculated and observed particle motion, and duplicate it in another environment, including but not limited to another entertainment space or a virtual environment, such as a metaverse. In some such embodiments the PRRRs may have PROS embedded in them and provide data on the users who are being entertained back to the entertainers being observed, such that a virtual performance can feel as immersive for the performer as for the observer. In some other embodiments, PRRRs may adjust replication based on one or more user selected criterion, such that the objective is not a 1:1 replication of sound, but rather adjusts the sound based on the environment, such as giving a recorded band a stadium sound as opposed to a garage sound regardless of where the performance is recorded, replicating the sound such that it sounds like it would in an underwater environment, or alternating the sound such that it sounds like it would in a glass dome, all based on the PROS observing, and the PRRRs calculating and adjusting based on how acoustic particles would travel in such virtual environments.

Examples of the present disclosure designed to inform users may include but are not limited to headsets or handheld scanners for use in the hospitality or commercial real estate industry that may observe the layout of a building and make recommendations for service in conjunction with AI in some such embodiments, based on user inputted data such as the age of the building, the date of the last renovation and the price of the building and provide feedback regarding the optimal use of space, the expected renovation cost and renovation needs and the respected return on investment and time until the break-even point is reached. One such example may be a spectrometer scanner that detects the presence of cracks in a buildings infrastructure based on thermographic temperature changes and the probability of the presence of air gaps being calculated such that a renovation involving new insulation is recommended, and the AI uses user generated input to improve its detection ability in the future based on information collected in the database regarding how often its detections of said air-gaps have been accurate as opposed to being caused by an alternative explanation.

### BRIEF DESCRIPTION OF THE DRAWINGS

Referring to the drawings, FIG. 1 is an illustration of an exemplary headset visor with PROS and PRRR technology (tech), in this case the PROS being used to detect a vehicle that has begun skidding out of control in the path of the user, alerting the user and guiding them to safety.

FIG. 2 is an illustration of an exemplary headset visor comprising PROS and PRRR tech, in this case detecting a drone overhead and directing the user both visually and using audio to its presence and location.

FIG. 3 is an illustration of an exemplary headset visor comprising PROS and PRRR tech, in this case interoperating with an oral surgery device with PROS and alert lighting, and the headset visor PRRRs responding and adjusting accordingly.

FIG. 4 is a drawing of an exemplary dental device in this case comprising PROS to observe the inside of a user's mouth and PRRRs to alert and guide an operator, dentist or oral surgeon accordingly.

FIG. 5 is a representation of a live musical performance being recorded by PROS and being replicated in an immersive environment with sound modification effects as part of the PRRR tech, such that the sound can be amplified or dampened according to the type of real or virtual environment selected.

FIG. 6 is an illustration of an exemplary headset visor comprising PRRR tech, in this case replicating a virtual concert based on a live performance, recorded performance or artificial intelligence generated or enhanced performance originally detected by PROS.

FIG. 7 is an exemplary flowchart showing the typical database hierarchy with data sent to and from a device including but not limited to a PROS/PRRR relay sensor device such as a headset or instrument and relayed into a virtual environment utilizing particle ray tracing AI software utilizing a virtual intranet, network or the internet.

FIG. 8 is an illustration of an exemplary building with PROS and PRRRs imbedded for purposes including but not limited to optimizing energy draw and predicting needs based on location and time, reacting to vibrations detected and sending alerts to users, or guiding debris in the event of an earthquake or natural disaster to protect people or property in the event of a disaster with the aid of artificial intelligence.

FIG. 9 is an exemplary flowchart showing the typical database hierarchy with data sent to and from a device including but not limited to a PROS/PRRR tech device such as a headset, mobile device or vibration dampener and relayed via a building internet utilizing particle ray tracing software utilizing a building's intranet, network or the internet.

FIG. 10 is an illustration of an exemplary headset visor comprising PROS tech and PRRR tech, in this case interacting with a building with PROS and PRRRs, allowing the user to perform a valuation of the building, detect defects in the building, price and plan repairs and guiding the user to safety in the event of a disaster, in some such embodiments alarms being generated to warn other building occupants when and where to shelter.

FIG. 11 is an exemplary embodiment of a user on a vehicle, in this case a hover scooter, outfitted with PROS, and the user wearing PRRRs embedded in safety devices, in this case a smart hat, elbow and knee pads, that inflate to protect the user from some degree of injury when a collision or fall is imminent.

FIG. 12 is an exemplary embodiment of a user wearing a protective suit with PROS and PRRRs embedded that assists the user in movement and detects when the user is falling to help them remain upright, improve their posture, or protect them from a more injurious fall accordingly.

FIG. 13 is an exemplary flowchart showing the typical database hierarchy with data sent to and from a device including but not limited to a particle relay monitoring device such as a sensor on a vehicle relaying detected dangers to a server utilizing particle ray tracing software utilizing a relay intranet, network or the internet and also relaying responses accordingly to one or more particle relay response devices somewhere in the geospatial environment such as inflatable pads or a protective suit further comprising protective PRRRs.

FIG. 14 is an exemplary flowchart showing the typical database hierarchy with data sent to and from a defect detection sensor or valuation device including but not limited to a PROS/PRRR relay sensor device such as a headset or instrument and relayed into a defect database utilizing a building valuation software via a building's network or the internet and further transmitting information to and from vibration detection and response devices in this example.

FIG. 15 is an image of an arrangement of particles transmitted between two or more outlets, turrets or trappings from where said particles are pushed, generated or released arrangement.

FIG. 16 is an arrangement of particles wherein two or more of said particles may interact to form a reflexive mirror.

FIG. 17 is an arrangement of particles wherein two or more of said particles may interact to change the direction of one another to guide a set of particles which may bounce off of them, the angle they form, or trail they leave behind.

FIG. 18 is an arrangement of particles transmitted between two or more outlets, turrets or trappings from where said particles can be used to push, direct or otherwise adjust one or more reflexive mirrors.

FIG. 19 is an arrangement of particles wherein two or more of said particles may be attracted to another and released in such a way that said attraction is used for propulsion, guidance or a change in properties, including but not limited to attracting the attention of or repulsion of one or more other said particles.

FIG. 20 is an exemplary flowchart showing the typical database hierarchy with data sent to and from a device including but not limited to a PROS/PRRR relay sensor transmission device such a laser or particle generator where AI may be used in some such embodiments to steer the path of the a particle arrangement and in some other embodiments mask the source of the beam if one or more of a preset, user defined or computer calculated particles are intercepted or observed by a path of directed particles.

### DETAILED DESCRIPTION

The disclosures herein relate to the design of one or more apparatuses, methods, and systems for monitoring, predicting, replicating and simulating particle ray tracing and interfacing said tracing with alert, response, measurement and entertainment systems or devices in an ergonomic fashion. In this case, ergonomic refers to ensuring that the technology interfaces with human users or humans impacted by it in a manner that is more useful, effective or comfortable for them. Among the objectives of this disclosure is to provide related variations to designs that protect users, guide users, inform users, or entertain users. In order to accomplish this feat, the disclosure requires one or more particle ray observation sensors (PROS), which observe particles and their movement and send a signal to one or more particle ray response relays (PRRR), which perform an action in response to a said signal. By ensuring the technology interfaces with users via sensors designed with their ergonomics in mind, the technology is better suited to guide humans, learn from humans, and help humans, especially when assisted by artificial intelligence (AI).

Some examples of variations of the present disclosure that are designed to protect users include but are not limited to one or more PROS and/or one or more PRRRs in a headset that may be used to provide a user with alerts, guidance, or protection, one or more PROS and/or one or more PRRRs in a surgical instrument, and one or more PROS and/or more PRRRs in a constructed or under construction facility. One such example for alerts for a headset may be a headset that can be used in conjunction with the operation of a vehicle including but not limited to bicycles, mopeds and motorized scooters, in which the PROS observes the motion of other particles, associates them with hazards, and sends a signal to PRRRs to guide the user on their path in relation to said observed or predicted particles. One such example for guidance for a headset may be a headset in embodiments that may have PRRRs that respond by alerting the user to a hazard via an audio signal, visual signal, or combination therein and guide the user to avoid a danger on their path. One such example for protection with a headset may involve embodiments that may have PRRRs separate from the headset, including but not limited to fluid expansion devices on pads, including but not limited to within a helmet, arm bands, leg bands or a safety suit, that inflate in response to an imminent collision, which may expand via means including but not limited to a release of hydraulic or pneumatic pressure.

Another such example for protection with a headset may involve embodiments that have PRRRs in the headset where sound dampening may be triggered in response to a loud noise being detected by the PROS so as to shield the user's ears, light dampening being triggered in response to a high lumens either detected or predicted by the PROS so as to shield the user's eyes, or the release of oxygen embedded in the headset, to protect the users life or olfactory senses, depending on the situation if a particularly noxious gas is detected by the PROS. One such example for protection in a surgical instrument may be an instrument for oral surgery with PROS embedded that detects that a user with TMJ's mouth is opened too wide for too long, based on observed particle data in conjunction with prior scans, and sends a signal to PRRRs, such as Bluetooth earphones worn by the oral surgeon, to pause so that the patient can relax their jaw. One such example of alerts, guidance and protection for a constructed or under construction facility may be PROS set up around a hotel, that sense vibrations from an earthquake, and send a signal to one or more PRRRs embedded in vibration dampening devices, to begin countermeasure movements in response to the magnitude of the earthquake detected, in some such embodiments, PROS detect the presence of users throughout the facility, and the PRRRs send a signal to guide responders to said areas, react to guide debris to less occupied areas, or send an alert to users when it is safe to move between tremors, so that they may safely exit the building. Other examples of embodiments meant to protect users may involve clothing or hardware with PRRRs that move in response to PROS on the user detecting fainting, falling or other undesirable movement, and guide the user to stand upright, or brace for impact in a way that will best shield them. In some such embodiments artificial intelligence may be used to record data regarding one or more users and provide guidance in the future to the users or the systems based on previously observed data and newly observed data, making calculations and adjusting over time, including by providing training and recommendations to users or systems in some such embodiments.

Examples of the present disclosure designed to entertain users may include but are not limited to audio/visual PROS that may observe or record a performance, PRRRs that may replicate said performance in another environment based on a combination of calculated and observed particle motion, and duplicate it in another environment, including but not limited to another entertainment space or a virtual environment, such as a metaverse. In some such embodiments the PRRRs may have PROS embedded in them and provide data on the users who are being entertained back to the entertainers being observed, such that a virtual performance can feel as immersive for the performer as for the observer. In some other embodiments PRRRs may adjust replication based on one or more user selected criterion, such that the objective is not a 1:1 replication of sound, but rather adjusts the sound based on the environment, such as giving a recorded band a stadium sound as opposed to a garage sound regardless of where the performance is recorded, replicating the sound such that it sounds like it would in an underwater environment, or alternating the sound such that it sounds like it would in a glass dome, all based on the PROS observing, and the PRRRs calculating and adjusting based on how acoustic particles would travel in such virtual environments.

Examples of the present disclosure designed to inform users may include but are not limited to headsets or handheld scanners for use in the hospitality or commercial real estate industry that may observe the layout of a building and make recommendations for service in conjunction with AI in some such embodiments, based on user inputted data such as the age of the building, the date of the last renovation and the price of the building and provide feedback regarding the optimal use of space, the expected renovation cost and renovation needs and the respected return on investment and time until the break-even point is reached. In some such embodiments adjustments in predictions may be made for valuations over time, or smaller valuations for optimal use of spaces including but not limited recommending mixed use spaces, depending on zoning laws, advising on which shops may be more profitable or recommending certain spaces for purposes including but not limited to warehouse storage, kitchen spaces, shelter space or recreational spaces can be incorporated into such some such systems. One such example may be a spectrometer scanner that detects the presence of cracks in a buildings infrastructure based on thermographic temperature changes and the probability of the presence of air gaps being calculated such that a renovation involving new insulation is recommended, and the AI uses user generated input to improve its detection ability in the future based on information collected in the database regarding how often its detections of said air-gaps have been accurate as opposed to being caused by an alternative explanation.

Referring to the drawings, FIG. 1 is an illustration of an exemplary headset comprising a visual visor 100 and side panels 102 and 104, which in some such embodiments may rest on a user's left ear and right ear accordingly, said headset incorporating PROS and PRRR technology (tech.) in this case the PROS being used to detect a vehicle 106 that has begun skidding out of control, as represented by a virtual oath being shown 108 in the path of the user, alerting the user visually 112 and guiding them 110 to safety.

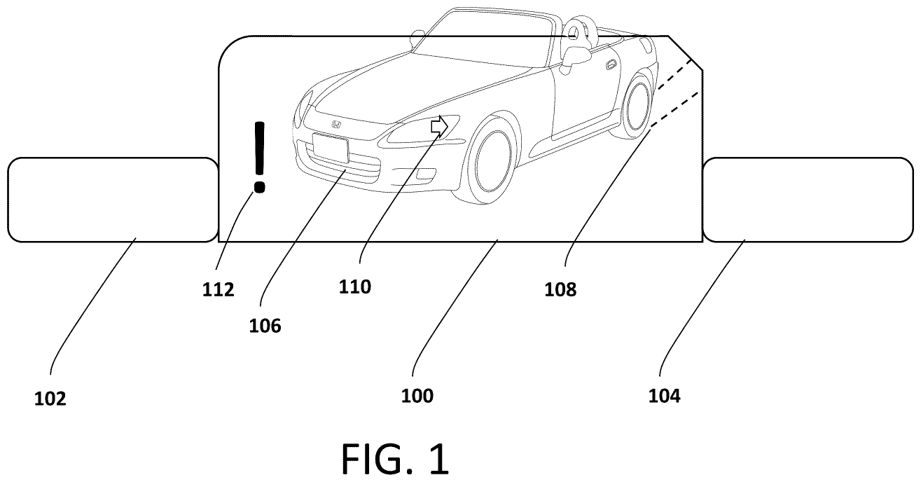

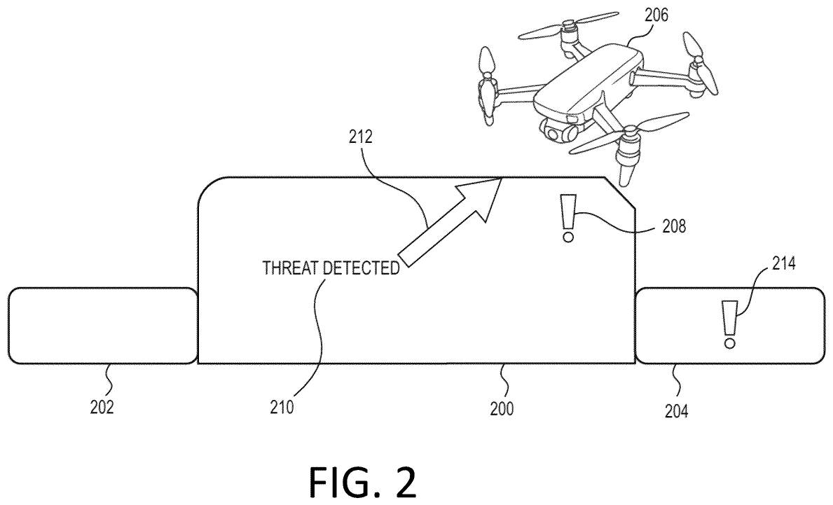

FIG. 2 is an illustration of an exemplary headset comprising a visual visor 200, comprising a left 202 and right 204 speaker. and PROS and PRRR tech, in this case detecting a drone 206 overhead and alerting them visually 208 and sonically 214, describing the issue 210 directing the use to its presence and location 212.

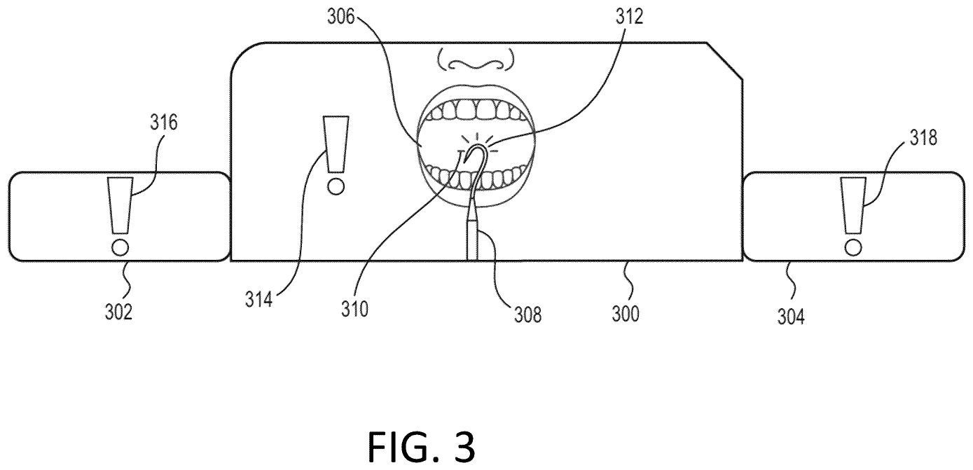

FIG. 3 is an illustration of an exemplary headset with a visual visor 300, left 302 and right 304 headphones, said headset comprising PROS and PRRR tech, in this case interoperating with an oral surgery device 308 detecting the contours of a patient's mouth 306 with PROS and alert lighting 310, and the headset visor PRRRs responding to the brightness 312 in some such embodiments darkening the visor to shield the user's eyes as needed, sending visual 314 or audio warnings to the user 316 and 318, on issues including but not limited to the presence of blood, gum sensitivity or to give the patient time to rest their jaw to avoid TMJ accordingly.

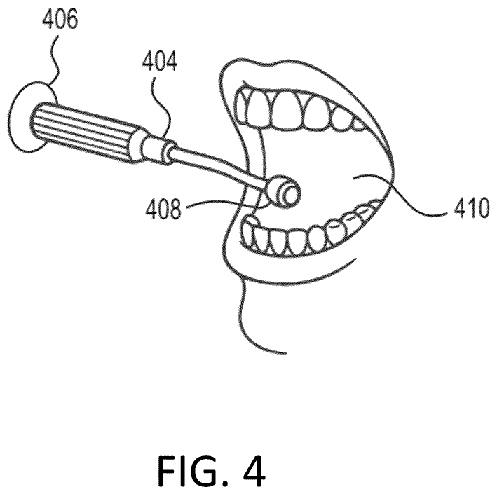

FIG. 4 is a drawing of an exemplary dental device 404 in this case comprising a PROS 408 to observe the inside of a user's mouth 410 and a PRRR 406 to alert and guide an operator, dentist or oral surgeon accordingly.

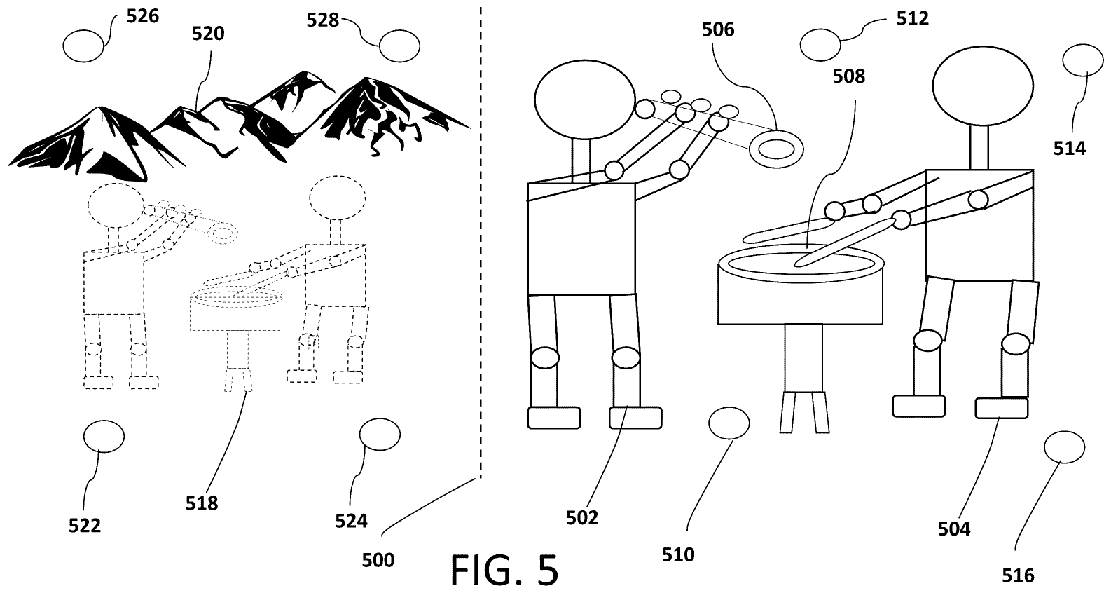

FIG. 5 is a representation of a live musical performance showing a trumpeter 502 and a drummer 504 being recorded both visually and the audio they make from playing the trumpet 506 and drum 508 by PROS 510, 512, 514 and 516 and being replicated 518 in an immersive environment with sound modification effects as part of the PRRR tech 522, 524, 526 and 528, such that the sound can be amplified or dampened according to the type of real or virtual environment selected, in this example the recorded environment being indoors, but the selected virtual environment being an outdoor area as represented by the mountains 520 with a divider 500 being used to represent the difference between the observed environment on the right and the virtual environment on the left. although they can be a world apart.

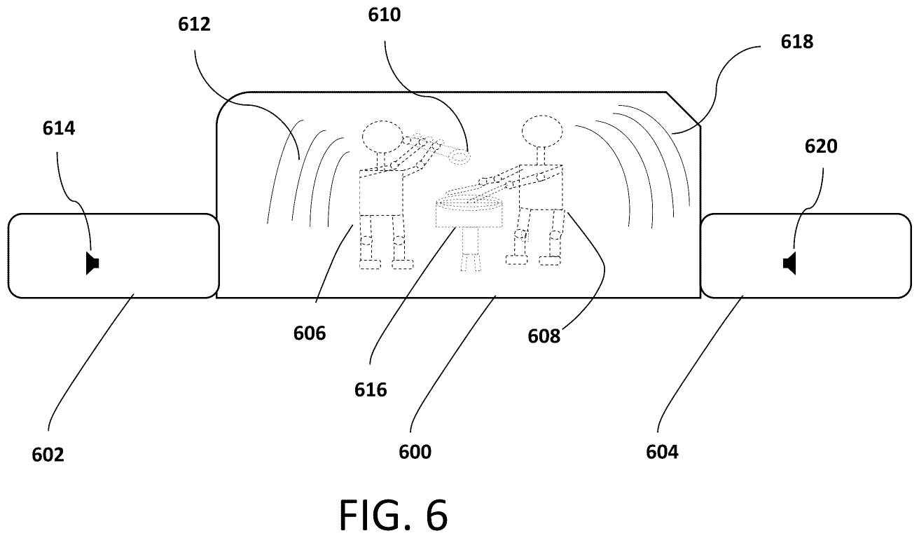

FIG. 6 is an illustration of an exemplary headset in this embodiment comprising a visual visor 600, a left 602 and right 604 earpiece all comprising PRRR tech, in this case replicating a virtual concert based on a live performance, recorded performance or artificial intelligence generating or enhancing performance originally detected by PROS in this case observing a trumpeter 606 and a drummer 608 playing a trumpet 610 and a drum 616 and observing and/or predicting the audio energy waves or particles emanating in directions including but not limited to the left 612 and right 618 and replicating them in PRRR speakers in locations including but not limited to the left 614 and right 620.

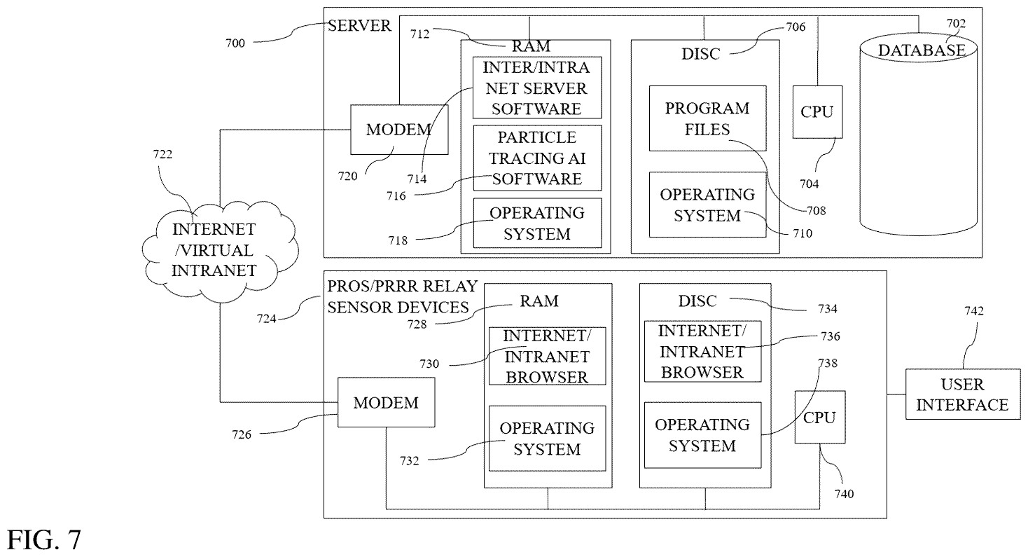

FIG. 7 is an exemplary flowchart an exemplary embodiment following a standard Internet architecture in which a PROS/PRRR relay sensor device such as a headset or instrument 724 and a server 700 are connected via the internet/or virtual intranet 722 and modems 726, 720 or other communications channels. A user accesses the server 700 via their headset or instrument interface 724 operating a web browser 730 or other software application residing in RAM memory 708 that allows it to display information downloaded from a server 700. The server system 700 runs server software 714, including the particle tracing AI software 716 of the present invention, which interacts with the PROS/PRRR relay sensor devices 724 and an information database 702. The database 702 contains information including but not limited to particle data, user habits and environmental attributes users. The particle tracing AI software 716 in some situations will notify any number of users of updates made to the database 702 regarding particle movement, including but not limited to vibration alerts, recommendations on navigation, guidance for better sound quality. Both the server 700 and the PROS/PRRR relay sensor devices 724 include respective storage devices, such as hard disks 706 and 734 and operate under the control of operating systems 718, 732 executed in RAM 712, 728 by the CPUs 704, 740. The server storage device 706 stores program files 708 and the operating system 710. Similarly, the user storage devices 734 store the inter/intranet browser software 736 and the operating systems 738. In some exemplary embodiments, the user would utilize the user interface 742 on their mobile device or headset to communicate between one or more PROS/PRRR relay sensor devices 724.

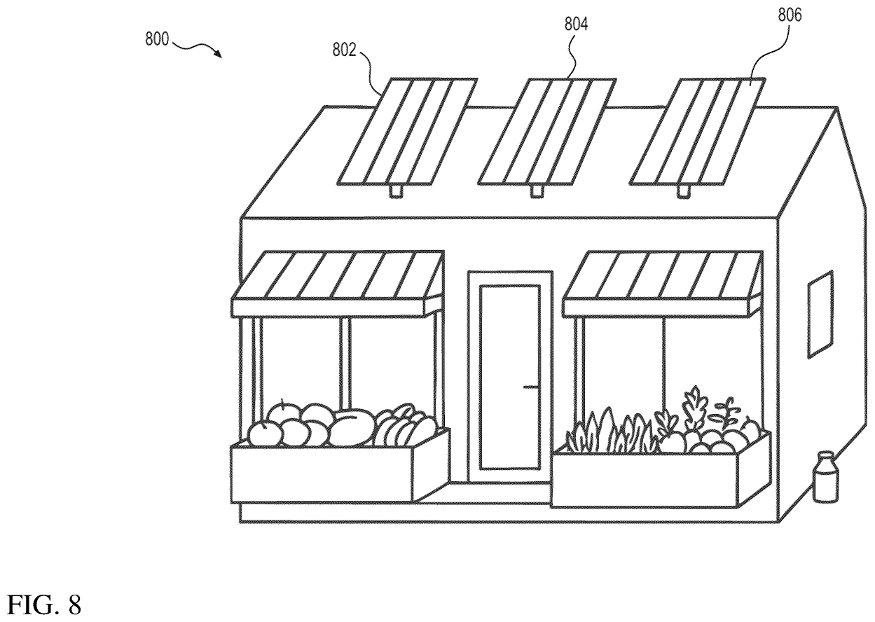

FIG. 8 is an illustration of an exemplary building 800 with PROS and PRRRs imbedded for purposes including but not limited to optimizing energy draw and storage from a solar panel on the roof 804 and predicting needs based on location and time, reacting to vibrations detected and sending alerts to users, or guiding debris in the event of an earthquake or natural disaster to protect people or property in the event of a disaster with the aid of artificial intelligence by pivoting the angle on an adjustable panel on the left 802 to tilt inward if users are sensed by the PROS standing near the walls, such that any falling debris from buildings or floors above the shop shown would be more likely to fall toward the center of the building or tilt an adjustable panel on the right 804 outward if users are not sensed by the PROS standing near the walls on that side, such that any falling debris from buildings or floors above the shop shown would be less likely to fall toward the center of the building, thus preventing blocking a path of escape.

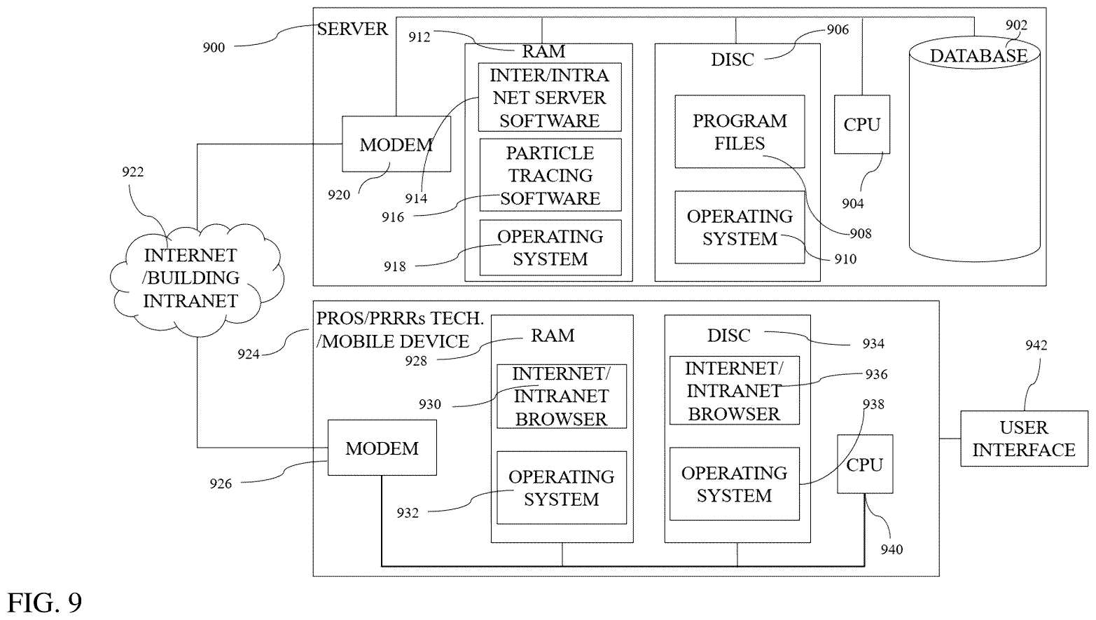

FIG. 9 is an exemplary embodiment following a standard Internet architecture in which user PROS/PRRRs tech/mobile device 924 and a server 900 are connected via the internet or building intranet 922 and modems 926, 920 or other communications channels. A user accesses the server 900 via the user interface on their headset or a mobile device or other user interface 924 operating an internet or intranet browser 930 or other software application residing in RAM memory 908 that allows it to display information downloaded from a server 900. The server system 900 runs server software 914, including the particle tracing software 916 of the present disclosure, which interacts with the PROS/PRRRs tech./mobile device 924 and a particle tracing information database 902. The database 902 contains building information which may be imported by means including but not limited to having it be entered by registered users, detected by AI, observed by PROS or some combination therein, particle information detected by PROS or relayed by PRRRs and adjusted by AI in some such embodiments, or equipment information for building components including but not limited to solar panels, vibration dampeners or adjustable panels which may be imported by means including but not limited to being uploaded from a manufacturer, imported from the internet or detected by one or more PROS. The particle tracing software 916 in some situations will notify any number of users of updates made to the database 902 regarding building components, maintenance needs, detected disturbances or predicted by AI. Both the server 900 and the PROS/PRRRs tech./mobile device 924 include respective storage devices, such as hard disks 906 and 934 and operate under the control of operating systems 918, 932 executed in RAM 912, 928 by the CPUs 904, 940. The server storage device 906 stores program files 908 and the operating system 910. Similarly, the user storage devices 934 store the inter/intranet browser software 936 and the operating systems 938. In some exemplary embodiments, the user would utilize the user interface 942 on their mobile device 924 to provide feedback to the system.

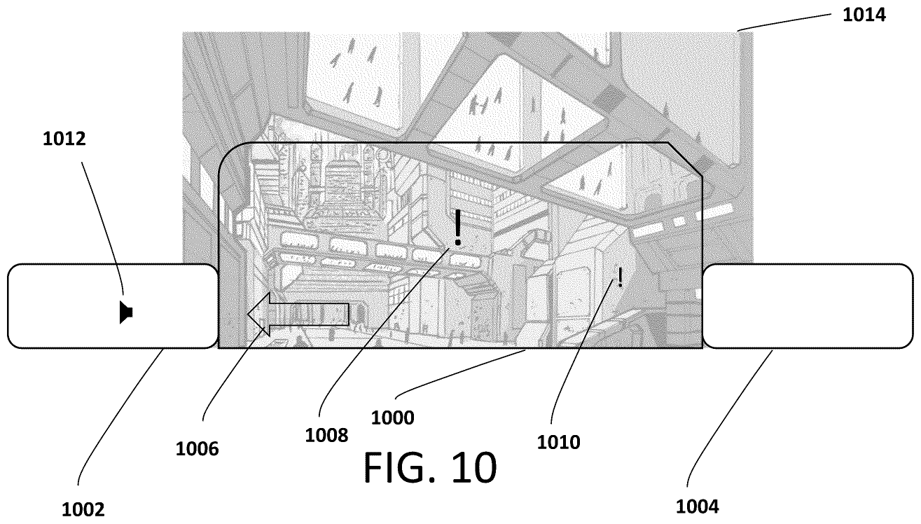

FIG. 10 is an illustration of an exemplary headset comprising a visor 1000, audio PRRRs 1002 and 1004 with additional PROS tech and PRRR tech imbedded. This PROS Tech may detect defects that appear or are beginning to appear in a building 1010, be used to value a building or parts therein such as the futuristic mall 1014 shown in the illustration, alert the user to hazards relayed by PRRRs in the building 1008 and direct the user to a safe space during a disaster such as an earthquake guiding the user in this case to shelter to the left visually 1006 and via audio speakers 1012. In some such embodiments the system may be designed to help a user estimate for purposes including not limited the value of a building for a purchase, the cost of renovations needed and the break-even point expected on the purchase.

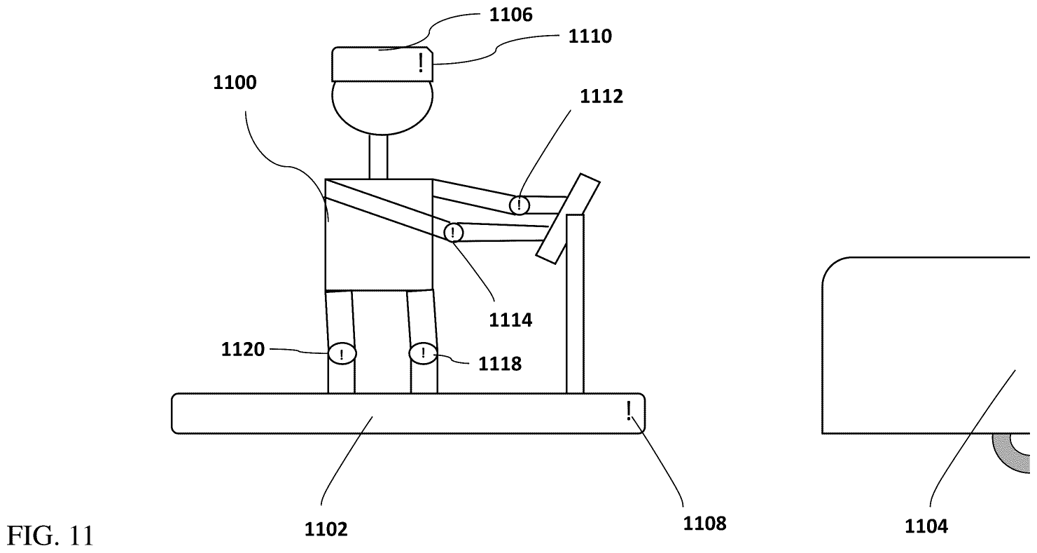

FIG. 11 is an exemplary embodiment of a user on a vehicle, in this case a hover scooter 1102, outfitted with PROS that detect hazards or potential collisions such as from an oncoming vehicle 1104 the user or the vehicle's steering system via reactive PRRRs 1108, or in some embodiments send signals to one or more PRRRs embedded in safety devices, in this case a smart hat 1106, elbow 1112 and 1114 and knee pads. 1118 and 1120 or an article of protective clothing 1100 that may inflate to protect the user from some degree of injury when a collision or fall is imminent or alert the user via a signal sent to a PRRR 1110 so they can avoid it. brace themselves for the injury or safety devices. or guide them how to avoid it.

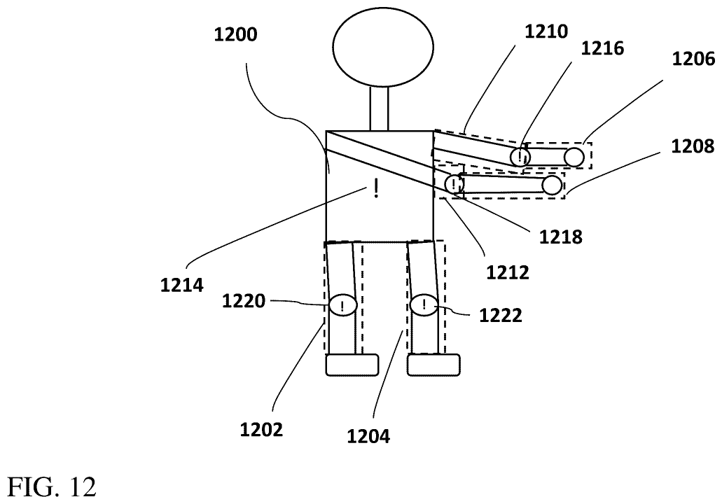

FIG. 12 is an exemplary embodiment of a user 1200 wearing a protective suit with PROS and PRRRs embedded that assists the user in movement and detects when the user is falling to help them remain upright, improve their posture, or protect them from a more injurious fall accordingly. In this case the protective suit may operate similar to an exoskeleton and guide the users legs 1202 and 1204 and/or arms 1210, 1206, 1208, 1212 when a signal is sent from PROS associated with a gyroscope or other geospatial sensor located on the user's body 1214, that detects the user falling and sends a signal to PRRRs located centrally to the legs of the user, such as around the leg joints 1202 and 1204 or arm joints 1216 and 1218, responding to guide the protective suit to protect the user.

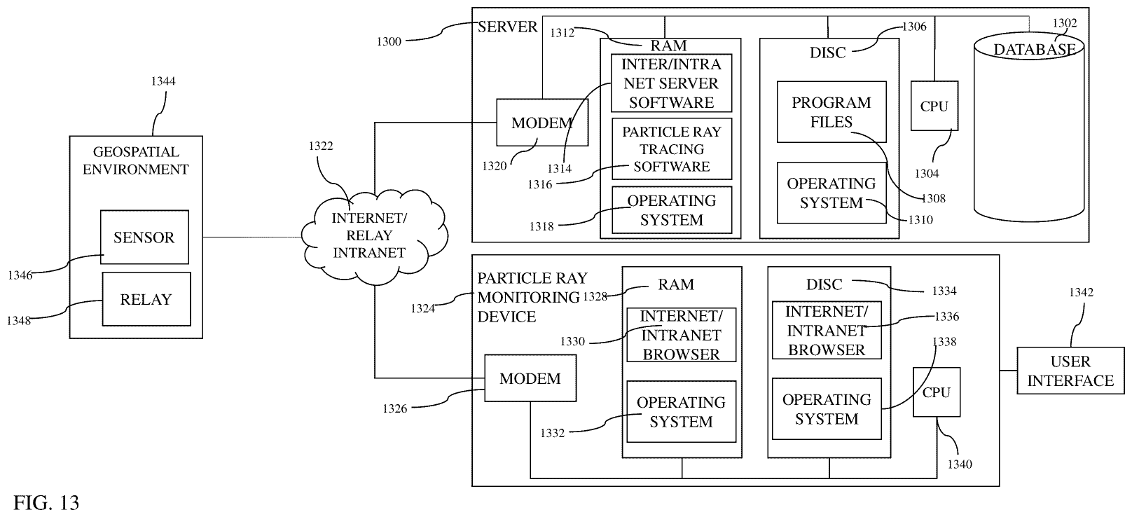

FIG. 13 is an exemplary embodiment following a standard Internet architecture in which a user interface 1342 a particle ray monitoring device 1324 and a server 1300 are connected via the internet or relay intranet 1322 and modems 1326, 1320 or other communications channels. A user accesses the server 1300 via the user interface on their headset or a mobile device or other user interface 1324 operating an internet or intranet browser 1330 or other software application residing in RAM memory 1308 that allows it to display information downloaded from a server 1300. The server system 1300 runs internet or intranet server software 1314, including the particle ray tracing software 1316 of the present disclosure, which interacts with the particle ray monitoring device 1324 and a particle tracing information database 1302. The database 1302 contains building information which may be imported by means including but not limited to having it be entered by registered users, detected by AI, observed by PROS or some combination therein, particle information detected by PROS or relayed by PRRRs and adjusted by AI in some such embodiments, or equipment information for building components including but not limited to solar panels, vibration dampeners or adjustable panels which may be imported by means including but not limited to being uploaded from a manufacturer, imported from the internet or detected by one or more PROS. The particle ray tracing software 1316 in some situations will notify any number of users of updates made to the database 1302 regarding building components, maintenance needs, detected disturbances or predicted by AI. Both the server 1300 and the particle ray monitoring device 1324 include respective storage devices, such as hard disks 1306 and 1334 and operate under the control of operating systems 1318, 1332 executed in RAM 1312, 1328 by the CPUs 1304, 1340. The server storage device 1306 stores program files 1308 and the operating system 1310. Similarly, the user storage devices 1334 store the inter/intranet browser software 1336 and the operating systems 1338. In some exemplary embodiments, the user would utilize the user interface 1342 on their mobile device 1324 to provide feedback to the system. Additional PROS 1346 and PRRRs 1348 may be imbedded in various parts of the Geospatial Environment 1344 and communicate to the said server(s) 1300 or particle ray monitoring device(s) 1324 via the internet or relay intranet 1322.

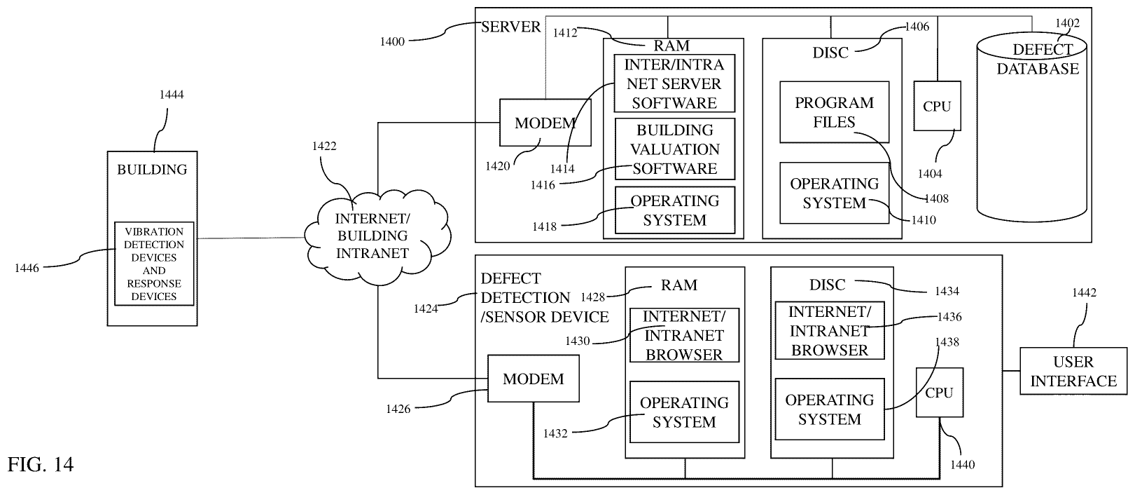

FIG. 14 is an exemplary embodiment following a standard Internet architecture in which a user interface 1442 a defect detection/sensor device 1424 and a server 1400 are connected via the internet or building intranet 1422 and modems 1426, 1420 or other communications channels. A user accesses the server 1400 via the user interface on their headset or a mobile device or other user interface 1424 operating an internet or intranet browser 1430 or other software application residing in RAM memory 1408 that allows it to display information downloaded from a server 1400. The server system 1400 runs internet or intranet server software 1414, including the building valuation software 1416 of the present disclosure, which interacts with the defect detection/sensor device 1424 and a defect database 1402. The database 1402 contains building information which may be imported by means including but not limited to scans by spectrometers, improved by user feedback and evaluated by AI, observed by PROS or some combination therein, particle information detected by PROS such as detection of cracks or leaks or relayed by PRRRs and adjusted by AI in some such embodiments, or equipment information for building components including but not limited to solar panels, vibration dampeners or adjustable panels which may be imported by means including but not limited to being uploaded from a manufacturer, imported from the internet or detected by one or more PROS. The building valuation software 1416 in some situations will notify any number of users of updates made to the database 1402 regarding building components, maintenance needs, detected disturbances or predicted by AI. Both the server 1400 and the defect detection/sensor device 1424 include respective storage devices, such as hard disks 1406 and 1434 and operate under the control of operating systems 1418, 1432 executed in RAM 1412, 1428 by the CPUs 1404, 1440. The server storage device 1406 stores program files 1408 and the operating system 1410. Similarly, the user storage devices 1434 store the inter/intranet browser software 1436 and the operating systems 1438. In some exemplary embodiments, the user would utilize the user interface 1442 which may be connected to a defect detection/sensor device 1424 to provide feedback to the system. Additional PROS and PRRRs may be imbedded in various parts of the building 1444 in the form of vibration detection devices and response devices 1446 and communicate to the said server(s) 1400 or defect detection device(s) 1424 via the internet or relay intranet 1422. In some exemplary embodiments of the present disclosure companion software capable of accessing data and adding comments, and quantitative evaluations and calculations of value through GUI may be integrated.

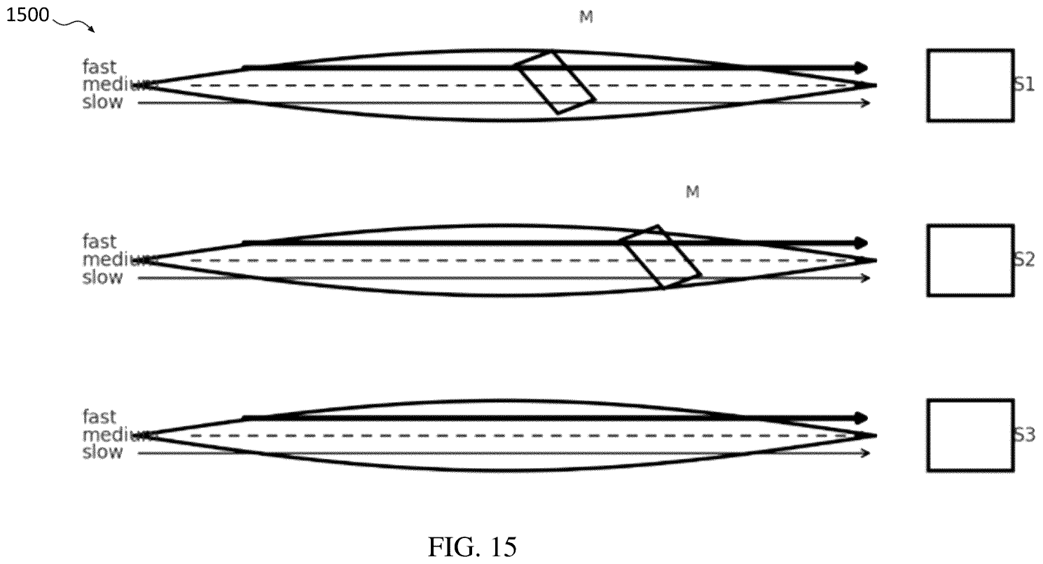

FIG. 15 is an exemplary image 1500 of an arrangement of particles transmitted between two or more outlets, turrets or trappings from where said particles are pushed, generated or released arrangement and in some such embodiments one or more streams of said first set of particles may be intentionally released manually, semi-autonomously or autonomously at a different velocity that one or more streams of a second set of particles that interact with said first set of particles. In this particular exemplary embodiment 3 different sets of particles are shown where at least three streams of particles may travel at different speeds, fast, medium or slow in each stream to form, move or direct one or more reflexive surfaces M, S1, S2 or S3 for guiding, directing, or reflecting the particles in one or more desired directions

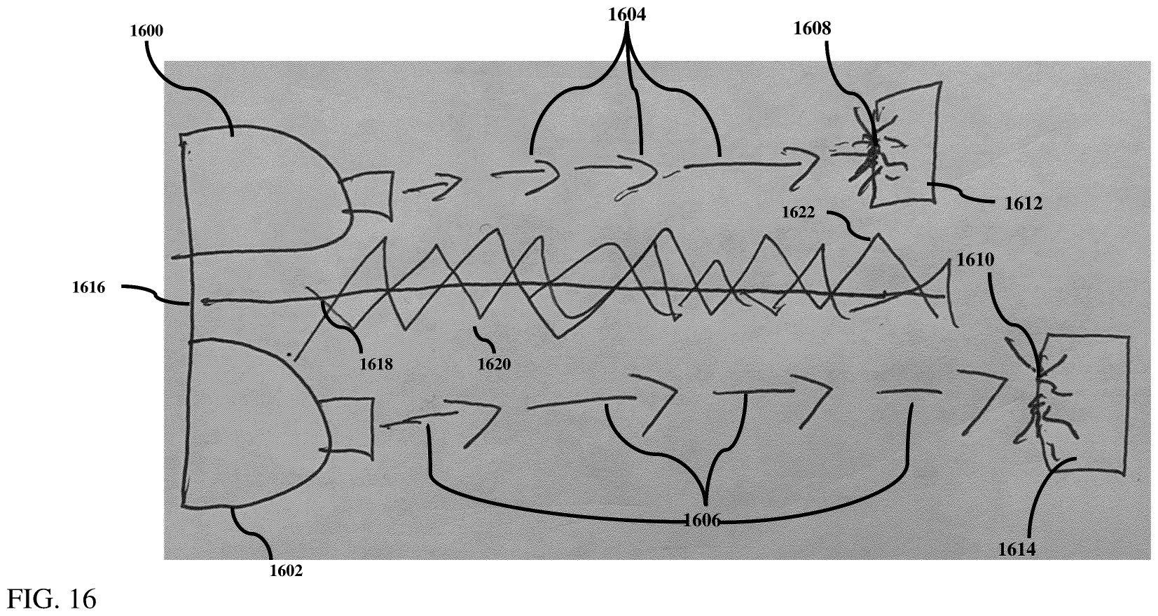

FIG. 16 is an arrangement of particles wherein two or more turrets 1600, 1602 may generate particle streams 1604, 1606 which may interact with their own streams at different speeds 1608, 1610 to form one or more reflexive mirrors 1612, 1614 and further wherein a stream of energy which may be a guided set of particles including but not limited to one or more lasers, light streams or particles containing information 1616, 1618 which may bounce 1620, 1622 which may bounce off the former generated particle streams 1604, 1606 or reflexive mirrors 1612, 1614.

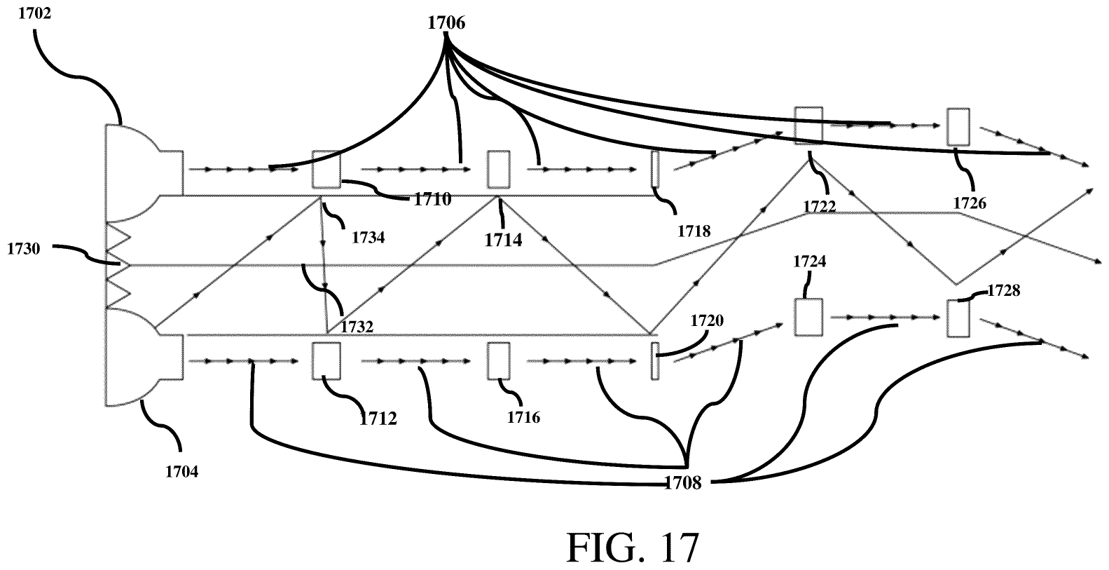

FIG. 17 is an arrangement of particles wherein two or more turrets 1702, 1704 may release 2 or more streams of particles 1706, 1708 which may interact to create, propel, and or direct one or more reflexive surfaces 1710, 1712 additional streams of particles further interacting to create, interact with and/or control one or more additional reflexive surfaces 1714, 1716, 1718, 1720, 1722, 1724, 1726, 1728 which may be entirely composed of a collection of particles interacting in some such embodiments of one another to guide a set of particles 1732 which may bounce off 1734 of them, the angle they form, or trail they leave behind. In some such embodiments the energy to generate such streams may be generated by exotic energy sources including but not limited to solar energy, metamaterial interactions, cold fusion or low-energy nuclear reactions.

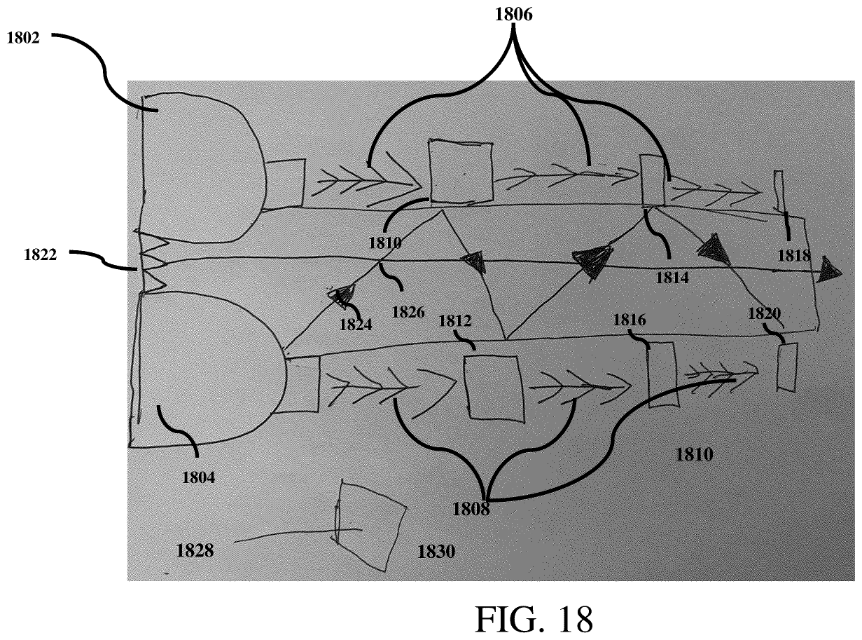

FIG. 18 is an arrangement of particles 1824, 1826 transmitted between two or more outlets 1802, 1804, turrets or trappings from where particles generated by said turrets or released by said trappings 1806, 1808 can be used to push, direct or otherwise adjust one or more reflexive mirrors 1810, 1812, 1814, 1818, 1820 where the mirrors created by particle interactions may be drawn in succession, or a stream of particles 1820 may also be shown propelling another such mirror 1830.

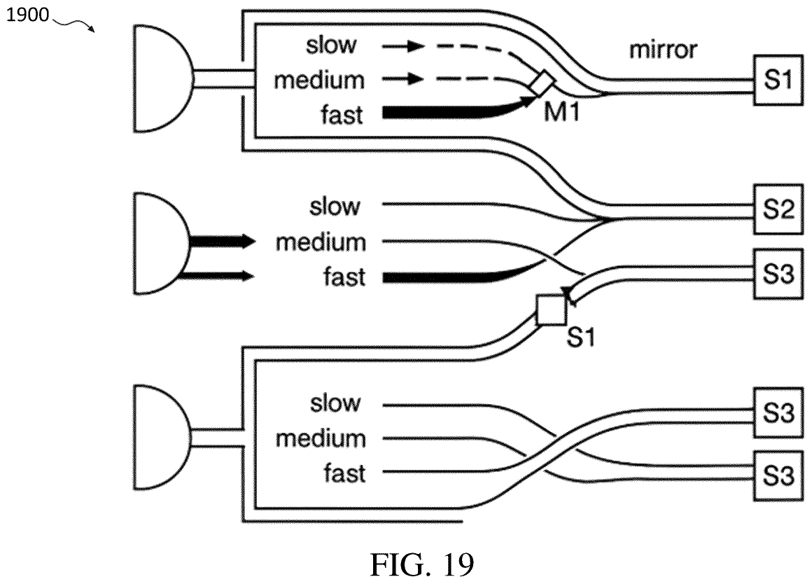

FIG. 19 is an exemplary arrangement 1900 of particles wherein two or more of said particles where each stream may be traveling at various speeds may be attracted to another and released in such a way that said attraction is used for propulsion, guidance or a change in properties, including but not limited to attracting the attention, which may lead to the creation of a reflective surface such as M1 of or repulsion which may lead to the creation of a propulsive mirror including but not limited to S1, S2 or S3 of one or more other said particles.

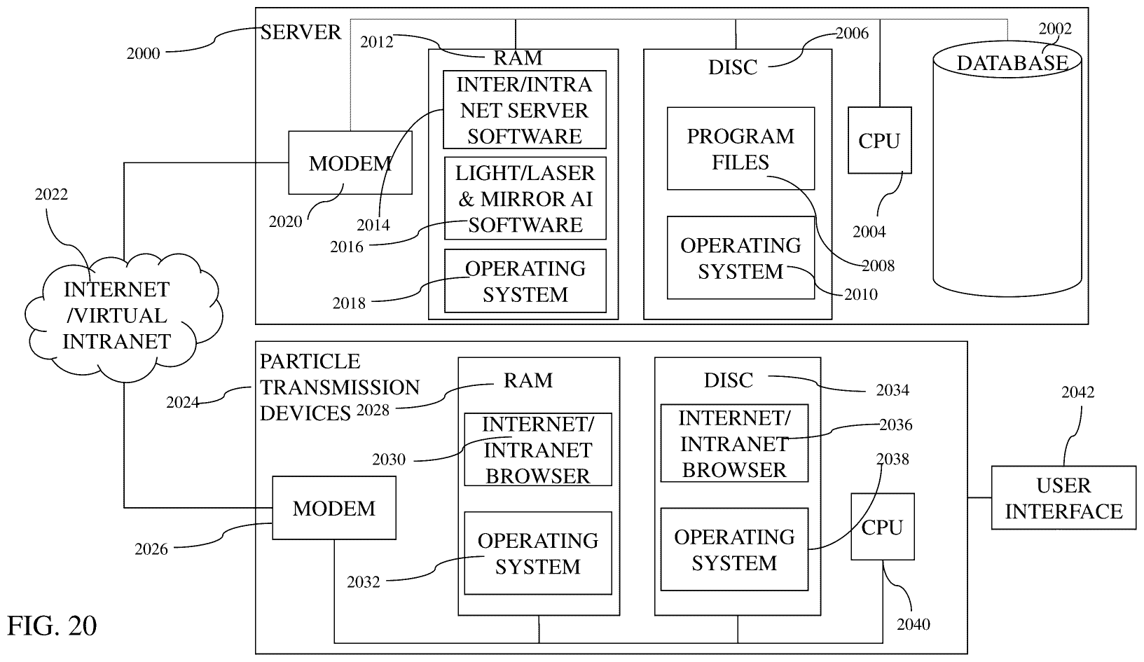

FIG. 20 is an exemplary flowchart an exemplary embodiment following a standard Internet architecture in which a particle transmission device such as a laser turret system and/or mirror generation particle cannon 2024 and a server 2000 are connected via the internet/or virtual intranet 2022 and modems 2026, 2020 or other communications channels. A user accesses the server 2000 via their headset or instrument interface 2024 operating a web browser 2030 or other software application residing in RAM memory 2008 that allows it to display information downloaded from a server 2000. The server system 2000 runs server software 2014, including the light/laser & mirror AI software 2016 of the present invention, which interacts with the particle generation devices 2024 and an information database 2002. The database 2002 contains information including but not limited to particle data, user habits and environmental attributes users. The light/laser & mirror AI software 2016 in some situations will notify any number of users of updates made to the database 2002 regarding particle movement, including but not limited to vibration alerts, recommendations on navigation, guidance for better sound quality. Both the server 2000 and the particle transmission devices 2024 include respective storage devices, such as hard disks 2006 and 2034 and operate under the control of operating systems 2018, 2032 executed in RAM 2012, 2028 by the CPUs 2004, 2040. The server storage device 2006 stores program files 2008 and the operating system 2010. Similarly, the user storage devices 2034 store the inter/intranet browser software 2036 and the operating systems 2038. In some exemplary embodiments, the user would utilize the user interface 2042 on their mobile device or headset to communicate between one or more particle transmission devices 2024.

In other exemplary embodiments capturing running data, workout data, health data, dental data, joining it with insurance data to predict ideal health behavior and/or risk for certain conditions is part of the design of the system. Other exemplary embodiments may involve audio recording and amplification with various modes that may be set including a beat-boxing mode, where a user can map certain user generated sounds to certain instruments, such that when observed or recorded by PROS in this mode it is converted and output in a real or virtual environment by PRRRs and mapped to one or more instruments such that the click of a tongue is mapped to a synthetic drumstick on snare drum sound, a rush of air between the teeth and the lips is made to sound like a wire brush hitting a snare, a push of air with a deep sound from the lips is meant to sound like a bass drum and a rush of air from the teeth and the tongue is mapped to sound like a crash cymbal being hit.

Some such embodiments may use metamaterials with exotic properties including but not limited to strong enhancement for of nonlinear optical phenomena, Li—Pd—Rh—D2O electrochemistry MeV energy particles with considerable reduction in energy loss properties and manganese Heusler alloys to continue to power AI enhancements to the PROS and PRRR transmission such that relays may be created in an environment by means including but not limited to laser-induced transfer, cutting or other material reformation or processing for communication, signal interception detection or signal scrambling.

It is understood that the various embodiments are shown and described above to illustrate different possible features of the invention and the varying ways in which these features may be combined. Apart from combining the different features of the above embodiments in varying ways, other modifications are also considered to be within the scope of the invention.

The invention is not intended to be limited to the embodiments described above, but rather is intended to be limited only by the claims set out below. Thus, the invention encompasses all alternate embodiments that fall literally or equivalently within the scope of these claims.

1. Particle tracing and duplication in a real or virtual environment utilizing visual sensing for recording of imaging using one or more input devices (including but not limited to cameras, one or more microphones, one or more sensors) and/or one or more output devices, said output devices being real or virtual.

2. The system in claim 1 wherein said cameras, microphones or sensors move in response to the light or lack thereof, sound or lack thereof, or signal or lack thereof received by one or more such input devices.

3. The system in claim 1 wherein said input devices may be combined as part of a multi-purpose input device.

4. The system in claim 1 further comprising Artificial Intelligence for monitoring, relaying or providing suggestions to one or more users.

5. The system in claim 1 further comprising a connection to one or more real audio output devices such that upon the detection of the start or end of playing of one or more instruments, autonomously transmits a signal to optimize one or more of said real audio output devices.

6. The system in claim 1 further comprising a connection to one or more virtual output devices such that one or more recorded performers (including but not limited to bands, singers and entertainers) can be recreated in a virtual environment as well as the unique sounds and location that may alter depending on the environment selected for an immersive experience that can be optimized based on one or more user selected or pre-selected optimum environments.

7. The system in claim 1 wherein one or more hospitality service monitors is incorporated for detection of when one or more bands finishes a set, one or more incidents occurs, or one or more patrons or workers requests service (said monitors utilizing particle dampening techniques to discern noise from needs in said environments).

8. The system in claim 6 further incorporating one or more real or virtual sound pads and the ability to map a location for said powers in both real and virtual environments.

9. The system in claim 8 wherein pads are embedded in one or more articles of clothing.

10. The system in claim 1 wherein tracing of one or more users can be utilized to provide recommendations to improve their performance

11. The system in claim 5 where packaged virtual instruments are provided which attract one or more particle tracing sensors.

12. The system in claim 1 further comprising one or more particle transmission devices that can be used to propel an arrangement of particles which may interact to form a reflexive mirror, change the direction of one another and otherwise guide a set of particles which may bounce off said particles the angle they form, or trail they leave behind.

13. An apparatus including a monitoring safety sensor relay, wherein when said safety sensor relay detects one or more objects or incidents, said safety sensor relay sends a signal to one or more safety devices.

14. The apparatus in claim 13 wherein said safety sensor relay may be imbedded in a visor

15. The apparatus in claim 14 wherein said safety sensor relay may be attached to one or more helmets and said helmets respond via direct connection to said visor and/or said helmet provides energy to said visor, and/or said helmet incorporates one or more sensors that send a signal to one or more safety relays

16. The apparatus of claim 13 wherein said visor provides directions (visual or audio)

17. The apparatus of claim 15 further comprising the ability to sense overhead objects and respond accordingly.

18. A method of valuating a building or optimizing the usage of space comprising a sensor with PROS transmitting detected information to a database comprising building valuation software, said database storing information processed by an operating system regarding the likelihood of defects and estimating the cost of remediation and adjusting the value of the building accordingly while relaying one or more building optimization recommendations to one or more users.

19. The method of claim 18 further comprising the steps of installing one or more vibration detection or response PROS or PRRs throughout the building to adjust the value according to sensed tremors and send alerts to one or more users in the event vibrations are detected within or above a preset or user defined range.

20. The method of claim 19 further comprising human or property detection PROS and debris guidance based PRRRs to adjust the angle of one or more rotating slats in the building so as to guide debris away from people or property based on predefined or user defined inputs or ai generated valuations.
